(19) United States
(12) Patent Application Publication
(10) Pub. No.: US 2023/0131976 A1
(43) Pub. Date: Apr. 27, 2023

(54) COMMUNICATION SYSTEM AND COMMUNICATION METHOD

(71) Applicant: NIPPON TELEGRAPH AND TELEPHONE CORPORATION, Tokyo (JP)

(72) Inventors: Hiroya ONO, Musashino-shi, Tokyo (JP); Toshihito FUJIWARA, Musashino-shi, Tokyo (JP); Shinya TAMAKI, Musashino-shi, Tokyo (JP)

(73) Assignee: NIPPON TELEGRAPH AND TELEPHONE CORPORATION, Tokyo (JP)

(21) Appl. No.: 17/915,571

(22) PCT Filed: Mar. 31, 2020
(86) PCT No.: PCT/JP2020/014760

§ 371 Date: Sep. 29, 2022

(51) Int. Cl. H04L 7/00

(52) U.S. Cl. CPC H04L 7/0012; H04L 7/0037

(57) ABSTRACT

An object of the present invention is to provide a communication system and a communication method that can avoid network congestion using a simple approach. The communication system of the present invention is characterized in that a time distribution server that transmits time information to terminals distributes a time different from the standard time for each terminal, and the terminal performs communication on the basis of the distributed time, and further characterized in that, for a time synchronizing packet transmitted from a time distribution server on the Internet to a terminal, a node or the like in the middle of the path performs transfer control or rewrites the packet, thereby causing the terminal to recognize a different time, and the terminal performs communication on the basis of the time.

### TECHNICAL FIELD

The present disclosure relates to a communication system and a communication method that control the time of a terminal.

### BACKGROUND ART

In recent years, IoT (Internet of Things) has started to spread, and the number of terminals (IoT terminals) that perform operation and communication based on a specific schedule is increasing. Examples include periodic transmission of log information from IoT sensors or an IoT GW (gateway) (which includes both a pattern of transmission at a specific time and a pattern of transmission at a specific cycle), and utterance, operation of an IoT terminal, or guidance of human behavior by a smart speaker at a reserved time.

When many IoT terminals perform the above operations, degradation in quality occurs due to an increase in the load on the server that collects IoT data or the congestion in the network (NW). It has been reported that, when actually simulating a situation in which IoT GWs start uploading data at a specific cycle, an increase in delay occurs when the transmission timings overlap (see, e.g., Non-Patent Literature 1).

In addition, the timing of generating periodic traffic depends on the time that the IoT terminal has, and, if no special setting is made, the IoT terminal often transmits data at a cycle of several seconds, several minutes, or several hours on the basis of the time of 0:00, or transmits data at a specified time. Therefore, the transmission timings of IoT terminals are difficult to disperse in time, and traffic is likely to occur in a burst at a specific time.

### CITATION LIST

### Non-Patent Literature

Non-Patent Literature 1: Y. Nie et al., “A first look at AMI traffic pattern and traffic surge for future large scale smart grid deployments”, INFOCOMP 2012: The Second International Conference on Advanced Communications and Computation
Non-Patent Literature 2: Tetsurou Nishioka, “A proposal of Mobile Data Offloading Protocol”, Multimedia, Distributed, Cooperative, and Mobile (DICOMO2014) Symposium, 2014.7
Non-Patent Literature 3: Kazuaki Honda, “A Proposal of Inter-L2SW Collaborative Shaping Technique in IoT Network”, the Institute of Electronics, Information and Communication Engineers, Society Conference 2019, B-8-2

### SUMMARY OF THE INVENTION

### Technical Problem

As a method for alleviating such congestion in the NW, there has been disclosed a technique in which a terminal communicates with a dedicated server in the NW to appropriately determine the transmission time for uploading and the content acquisition time for downloading (see, e.g., Non-Patent Literature 2). In the technique of Non-Patent Literature 2, a dedicated server is installed in a telecommunications carrier NW, and notifies terminals subordinate to the NW when communication is possible to alleviate congestion.

However, since the technique of Non-Patent Literature 2 requires communication with the server every time communication occurs, it has a problem that it is not efficient for alleviating periodic traffic such as that of IoT terminals. Therefore, it is less effective for applications with severe delay requirements.

Here, as load balancing methods for applications with relatively severe delay requirements, there have been known the following two techniques:

(A) A technique of providing a transfer device in the NW with a large enough buffer to drop the transfer bit rate; and
(B) A technique of controlling buffers of a plurality of transfer devices to drop the transfer bit rate as the entire NW (see, e.g., Non-Patent Literature 3).

The technique (A), has a problem that introduction of a dedicated transfer device is required.

In addition, the techniques (A) and (B) also have a problem that, when a large upload traffic has occurred, the delay increases if the amount of buffer or the number of devices is increased, resulting in degradation in communication quality or retransmission associated therewith, and the traffic amount can further increase.

In addition, when both the terminal and the application server can be controlled, it is also possible to configure them to cause an event or communication to occur at a time slightly different from the set time. For example, when an alarm is set at 7:00 with a smart speaker, it is set in granularity in minutes on the GUI (Graphical User Interface), but the server that controls the smart speaker can also control the alarm generation time in seconds or milliseconds.

However, this control requires implementation of a new function in individual applications, terminals, and servers, and it is required to implement the function in many pieces of equipment in order to perform load balancing throughout the communication network. Since it is difficult to add functions to end terminals, this control has a problem that it is difficult for NW operators to apply it. In order for NW operators to eliminate communication congestion, it is desirable that the NW operators can control many applications executed on terminals.

The above-described problems are summarized as follows.

The first problem is to establish a scalable traffic alleviation approach for larger bursty server loads and NW loads arising from automatic control equipment such as IoT terminals or their associated equipment operations or actions, and the like.

Then, the second problem is to make the traffic alleviation approach easy for telecommunications carriers to implement.

In order to solve the above problems, an object of the present invention is to provide a communication system and a communication method that can avoid network congestion using a simple approach.

### Means for Solving the Problem

In order to achieve the above object, a communication system according to the present invention is configured to cause a time different from the reference time (absolute time) for each IoT terminal to be falsely recognized as the reference time to synchronize with.

Specifically, a communication system according to the present invention includes

a time distribution unit that distributes a synchronization time to a plurality of terminals that periodically generate traffic,

in which the time distribution unit distributes a time different from a reference time to at least one of the terminals as the synchronization time.

Further, in a communication method according to the present invention, in a communication system in which a synchronization time is distributed to a plurality of terminals that periodically generate traffic, a time different from a reference time is distributed to at least one of the terminals as the synchronization time.

A terminal in a network has a function of setting a time notified from a time synchronization server or the time in a time synchronization packet transferred from an upper network as a reference time and synchronizing with this. This communication system and this communication method utilize this function. The time synchronization server in the network notifies a time different for each terminal as the reference time. Further, a transfer device shifts the time in the time synchronization packet and sets it as the time different for each terminal. Thus, since the reference time is shifted for each terminal, traffic is distributed. In addition, this approach can be realized without adding a new function to all pieces of equipment. Therefore, the present invention can provide a communication system and a communication method that can avoid network congestion using a simple approach.

Preferably, the communication system according to the present invention further includes an analysis unit that collects information on the traffic from the terminals, and determines the time different from the reference time.

In the communication system according to the present invention, the reference time is a standard time notified from an upper stratum of the communication system, and the time distribution unit is a time synchronization server that generates the time different from the reference time based on the standard time.

In the communication system according to the present invention, the reference time is a time notified from a time synchronization server in an upper network of the communication system via a time synchronization packet, and the time distribution unit is a transfer device that rewrites the time in the time synchronization packet to the time different from the reference time.

Note that the above inventions can be combined as long as the combination is possible.

### Effects of the Invention

The present invention can provide a communication system and a communication method that can avoid network congestion using a simple approach.

### BRIEF DESCRIPTION OF DRAWINGS

FIG. 1 is a diagram illustrating a communication system according to the present invention.

FIG. 2 is a diagram illustrating the communication system according to the present invention.

FIG. 3 is a diagram illustrating the communication system according to the present invention.

FIG. 4 is a diagram illustrating the communication system according to the present invention.

FIG. 5 is a diagram illustrating the communication system according to the present invention.

FIG. 6 is a diagram illustrating the communication system according to the present invention.

FIG. 7 is a diagram illustrating operation of the communication system according to the present invention.

FIG. 8 is a diagram illustrating operation of the communication system according to the present invention.

FIG. 9 is a diagram illustrating operation of the communication system according to the present invention.

FIG. 10 is a diagram illustrating the communication system according to the present invention.

FIG. 11 is a diagram illustrating the communication system according to the present invention.

FIG. 12 is a diagram illustrating the communication system according to the present invention.

FIG. 13 is a diagram illustrating the shift between the time recognized by the terminal and the standard time.

FIG. 14 is a diagram illustrating the shift between the time recognized by the terminal and the standard time.

FIG. 15 is a diagram illustrating operation of the communication system according to the present invention.

FIG. 16 is a diagram illustrating a communication method according to the present invention.

### DESCRIPTION OF EMBODIMENTS

Embodiments of the present invention will be described with reference to the accompanying drawings. The embodiments described below are examples of the present invention, and the present invention is not limited to the embodiments below. Note that, in the specification and the drawings, components having the same reference numeral shall indicate the same components.

(Gist of the Invention)

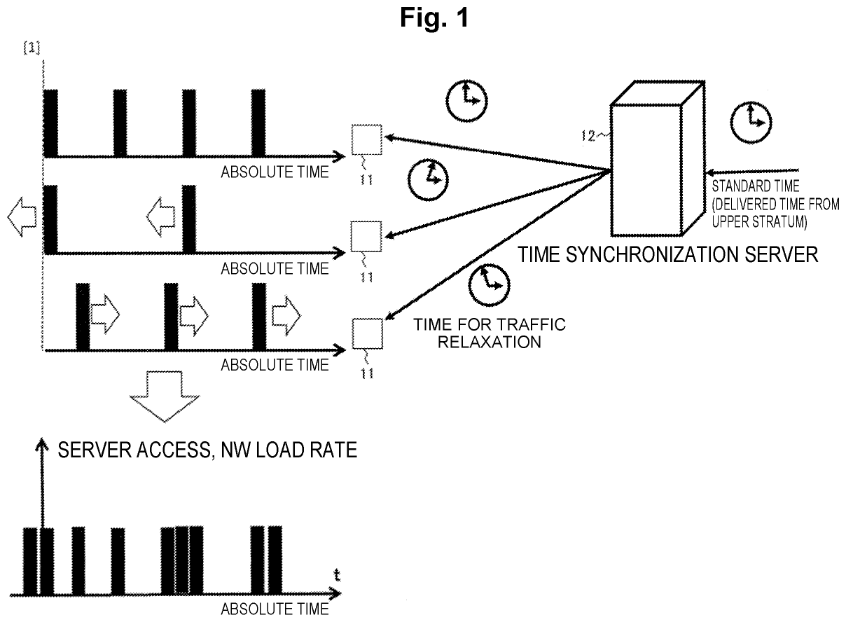

FIGS. 1 to 3 are diagrams illustrating the gist of the present invention. In the present invention, it is assumed that a certain amount of shift is allowed for the timing (absolute time) when a terminal transmits data (this assumption is the same as in the prior art). In addition, it is assumed that a time synchronization function is implemented in a terminal that generates traffic, and the time is controlled from outside the terminal.

A communication system of the present invention includes a time distribution unit 12 that distributes a synchronization time to a plurality of terminals 11 that periodically generate traffic, in which the time distribution unit 12 distributes a time different from a reference time to at least one of the terminals as the synchronization time.

The communication system of the present invention prevents overlapping of transmission timings from a plurality of terminals by utilizing a time synchronization protocol.

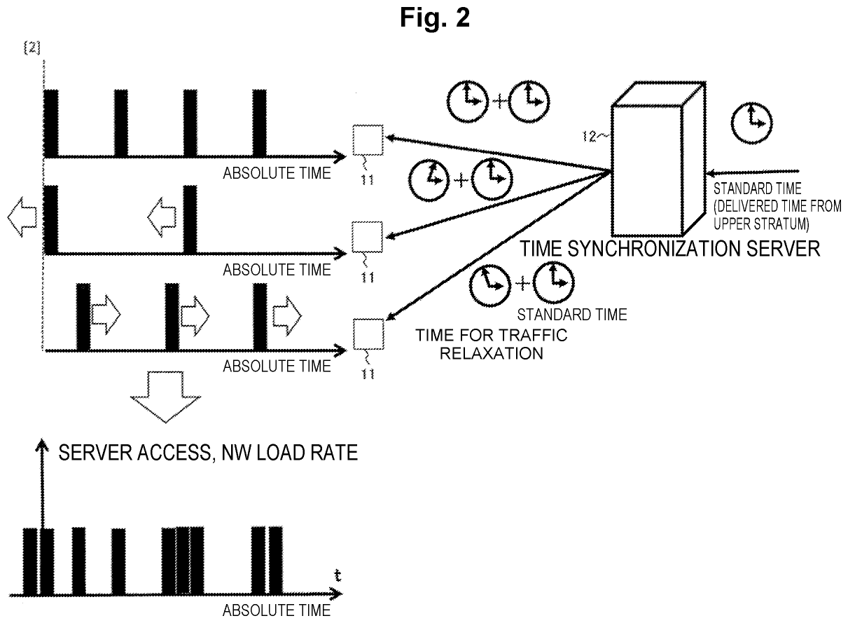

In a first approach of the communication system of the present invention, the reference time is a standard time notified from an upper stratum of the communication system, and the time distribution unit 12 is a time synchronization server that generates the time different from the reference time based on the standard time. In the first approach, as shown in FIGS. 1 and 2, a time distribution server (which corresponds to a time synchronization server or the like) that transmits time information to terminals distributes a time different from the standard time for each terminal, and the terminal performs communication on the basis of the distributed time.

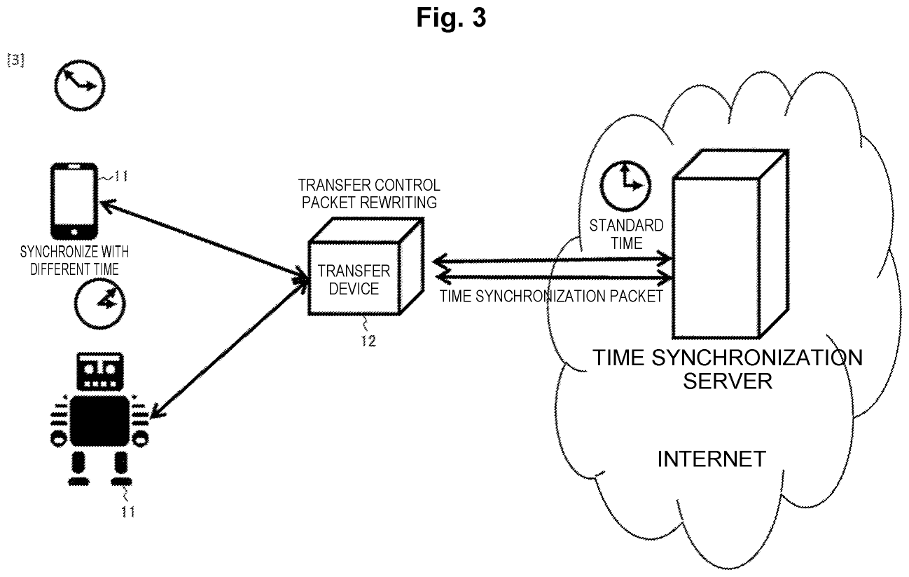

In a second approach of the communication system of the present invention, the reference time is a time notified from a time synchronization server in an upper network of the communication system via a time synchronization packet, and the time distribution unit 12 is a transfer device that rewrites the time in the time synchronization packet to the time different from the reference time. In the second approach, as shown in FIG. 3, for a time synchronizing packet with the standard time transmitted from a time distribution server on the Internet to a terminal, a node (transfer device) or the like in the middle of the path performs transfer control or rewrites the packet and transfers a time synchronizing packet with a time different from the standard time for each terminal to the terminal, and the terminal performs communication on the basis of the time.

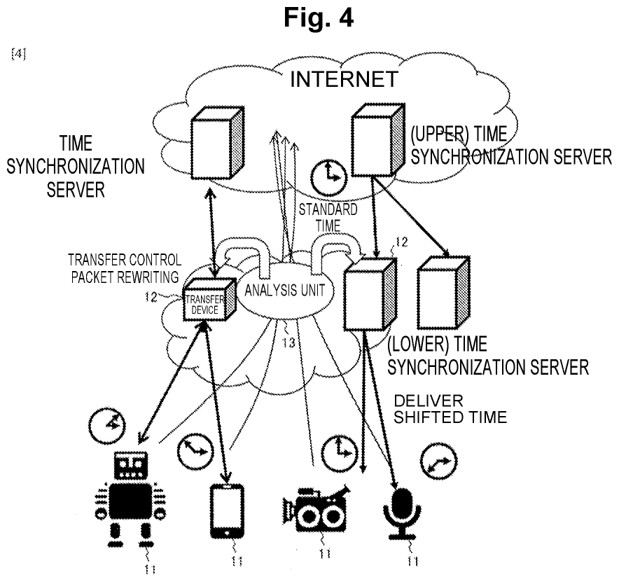

FIG. 4 is a diagram illustrating that the communication system of the present invention further includes an analysis unit 13 that collects information on the traffic from the terminals, and determines the time different from the reference time.

The analysis unit 13 acquires traffic information in a NW such as in a communication carrier network, and determines a distributed time to the terminal according to the traffic pattern of the terminal 11. Originally, the time synchronization protocol fine-tunes the distributed time based on network delay and the like. The analysis unit 13 acquires the generation cycle of traffic generated as client information, the bit rate at the time of generation of traffic, and the like from the terminal 11, and determines the distributed time. The time determined by the analysis unit 13 is notified from the time synchronization server or the transfer device to the terminal 11. That is, this communication system can smooth traffic and reduce congestion by controlling the distributed time from the time synchronization server or the transfer device to each terminal.

For example, when the analysis unit 13 detects that an event in which a traffic amount is generated in a burst has occurred periodically, it detects the IP address of the terminal 11 generating the periodic traffic. Then, the analysis unit 13 performs calculation such as increasing the shift amount for the time of distribution to the terminal 11 if the traffic amount is large, and decreasing the time shift amount if the traffic amount is small.

When the time distribution unit 12 is a time synchronization server, the time synchronization server does not distribute a time distributed from the upper stratum as it is, but determines an actual distributed time based on the time distributed from the upper stratum and client information subordinate to the time synchronization server. Further, when the time distribution unit 12 is a transfer device, the transfer device does not distribute a time synchronizing packet with the standard time transmitted from the upper network as it is, but determines a time to which the time synchronizing packet is rewritten based on the standard time and client information subordinate to the transfer device. The terminal 11 operates with an existing time synchronization protocol, and RTC (Real-Time Clock) is rewritten to the distributed time.

### Embodiment 1

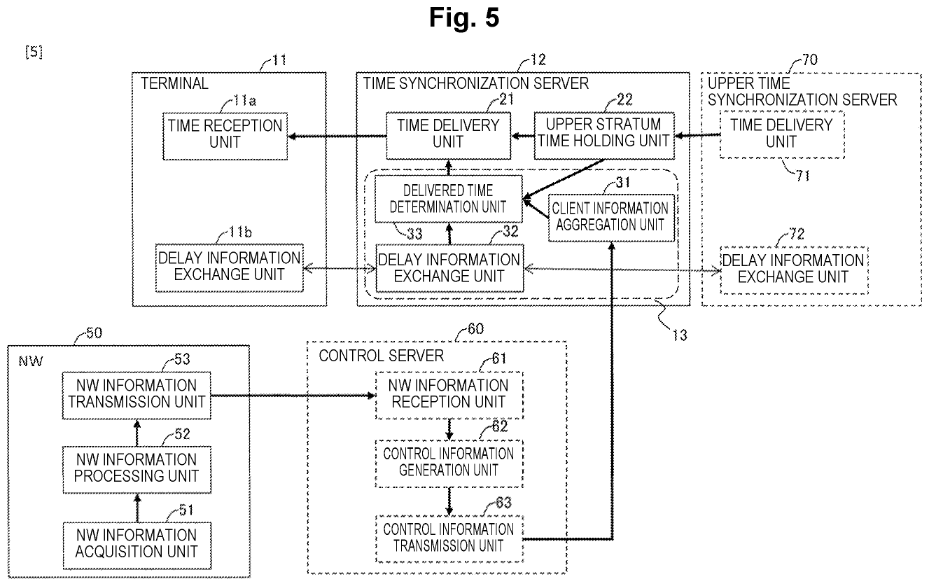

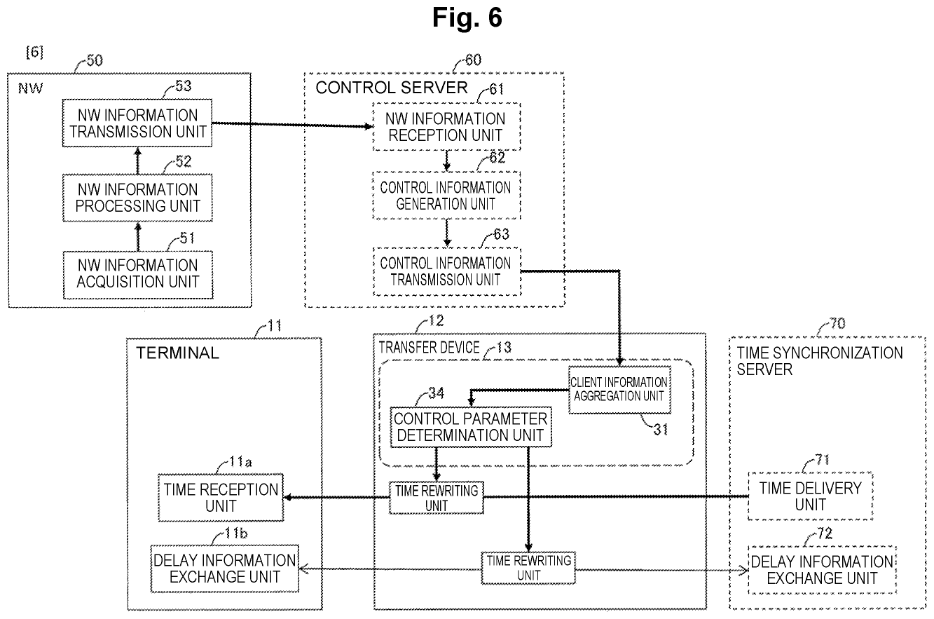

FIGS. 5 and 6 are functional block diagrams illustrating a communication system of this embodiment. FIG. 5 illustrates a case where the time distribution unit 12 is a time synchronization server, and FIG. 6 illustrates a case where the time distribution unit 12 is a transfer device.

In addition to time synchronization that takes into account the delay of a time synchronization packet and the like, this communication system includes a function group for exchanging NW information so that a time considering the NW state and traffic pattern can be distributed to each terminal 11.

A NW 50 monitors traffic of users (terminals 11) subordinate to the NW in a NW information acquisition unit 51, and calculates statistical amounts or feature amounts to extract terminals 11 that generate a traffic pattern in a NW information processing unit 52. NW information generated by the NW information processing unit 52 is transmitted from a NW information transmission unit 53 to the time synchronization server 12 and the transfer device 12. The time synchronization server 12 and the transfer device 12 performs time control based on the information.

Further, the NW information transmitted from the NW 50 may be routed through a control server 70 before reaching the time synchronization server 12 and the transfer device 12. In that case, a control amount (the shift of a distributed time and an amount of transfer delay to be given) to be applied by the time synchronization server 12 and the transfer device 12 to each client is derived by a control information generation unit 62 in the control server 70. A control information transmission unit 63 transmits the control amount directly to the time synchronization server 12 and the transfer device 12.

FIG. 5 is a diagram illustrating functional blocks of the time synchronization server 12. A client information aggregation unit 31 of the time synchronization server 12 receives and aggregates information (the control amount) on clients (terminals 11) contributing to generation of a specific traffic pattern from the NW 50 or the control server 60. Thereafter, a distributed time determination unit 33 determines a distributed time to each terminal 11 based on the information and standard time information obtained from an upper time synchronization server 70. The determined distributed time is transmitted from a time distribution unit 21 to the terminal 11. When a distributed time to each terminal 11 is also notified from the control server 70, the time of the terminal 11 is synchronized according to the distributed time.

FIG. 6 is a diagram illustrating functional blocks of the transfer device 12. The client information aggregation unit 31 of the transfer device 12 receives and aggregates information on clients (terminals 11) contributing to generation of a specific traffic pattern from the NW 50 or the control server 60. Thereafter, a control parameter determination unit 34 determines a control amount (such as a delay addition amount) for each terminal 11 based on the information. A time rewriting unit 35a rewrites the time written in a time synchronization packet transferred from the time synchronization server 70 to the determined time, and transmits it to the terminal 11. When a control amount for each terminal 11 is also notified from the control server 70, the time of the terminal 11 is synchronized according to the distributed time.

Functions common to the case of FIG. 5 and the case of FIG. 6 will be described.

### [1. How to Shift Time]

1-1. The time synchronization server (12, 70) randomly distributes a time to the terminal 11.
1-2. The analysis unit 13 controls the shifted time for each terminal 11 in accordance with a specific algorithm. (Example) The time shift is increased for clients with a high bit rate among terminals contributing to burst traffic.

### [2. Width of Shifted Time]

The order of the width of the shifted time does not matter (examples where shifting methods with various time widths are conceivable are shown below as reference).

(Example 1) In the case of IoT traffic, a shift amount may be on the order of milliseconds.
(Example 2) In such a case that reception of video streaming is started at a specific time, a shift amount in seconds is required. This is because the bit rate tends to increase for a few seconds at the start of viewing for accumulation in a buffer.

Next, the case where the time synchronization server 12 is provided shown in FIG. 5 will be described.

### [3A. Contents Notified by Time Synchronization Server to Client]

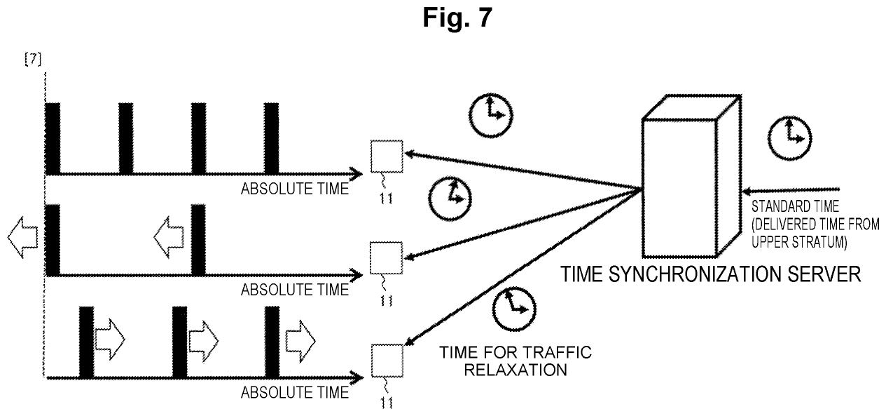

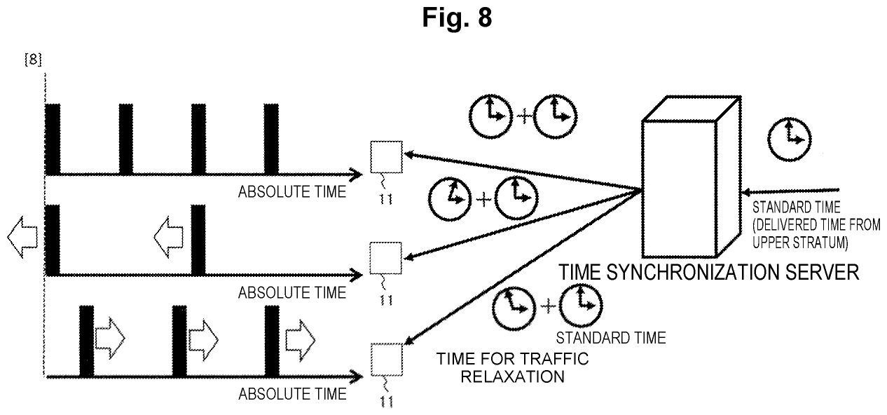

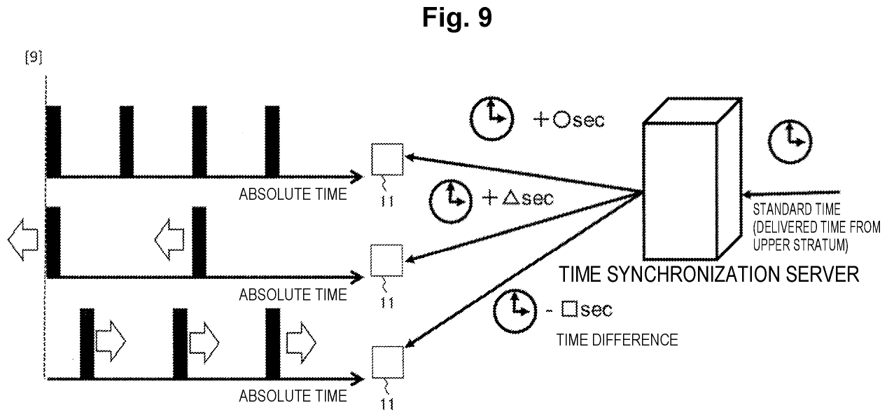

3A-1. A case to notify a shifted time as shown in FIG. 7
3A-2. A case of notifying both the correct time and a shifted time as shown in FIG. 8
3A-3. A case of notifying the correct time and a shifted time width as shown in FIG. 9

[4A. Correction of Shift Amount of Time]

These cases correspond to the cases in FIGS. 8 and 9.

4A-1. An OS and application basically recognize the shifted time distributed from the time synchronization server, but rewrite log information to have the standard time (correct time).

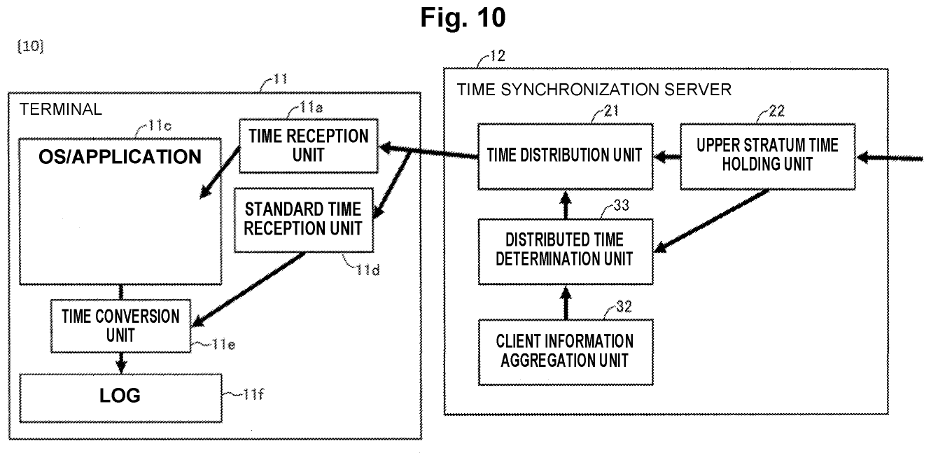

As shown in FIG. 10, the OS and application 11c operate based on a synchronization time received by a time reception unit 11a. However, when acquiring log information 11f of an operation time or a communication time, the OS and application 11c record a timestamp based on the standard time received by a standard time reception unit 11d. As a result, the time of the log is the correct time (standard time), so data reference from an external terminal at a later time will not be affected.

4A-2. The time of the OS is set to the standard time, and the time is converted by an interface with the application. The time recognized by the application is shifted.

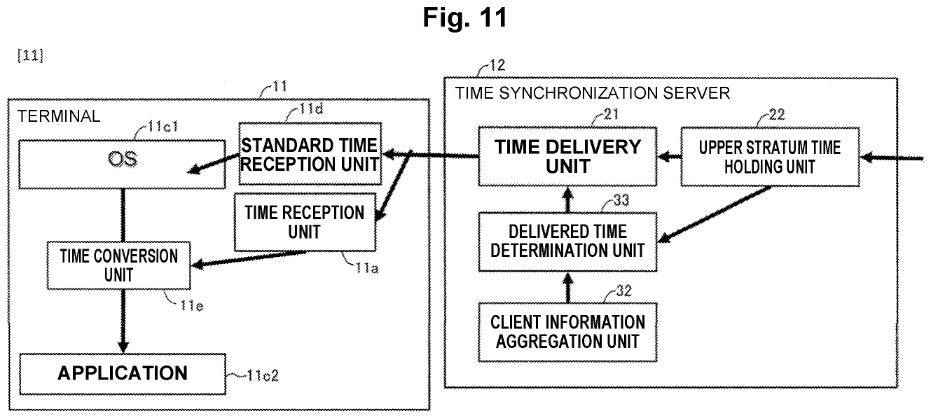

As shown in FIG. 11, the OS 11c1 of the terminal 11 synchronizes the time based on the standard time distributed from the time synchronization server 12, and also holds another shifted time. The OS 11c1 operates based on the standard time. On the other hand, the time to be passed to the application 11c2 is rewritten to a time shifted from the standard time in a time conversion unit 11e. This also results in the log information and the like of the OS 11c1 being recorded with the correct time, and data reference from an external terminal will not be affected.

4A-3. The standard time (so-called correct time) in the region is displayed on the UI.

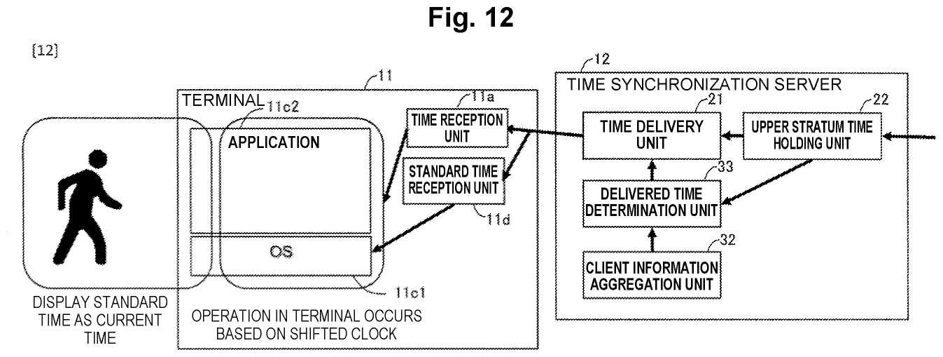

As shown in FIG. 12, the OS 11c1 of the terminal 11 synchronizes the time based on the standard time distributed from the time synchronization server 12. The application 11c2 operates based on a shifted time distributed from the time synchronization server 12. On the other hand, the screen display time seen by the user, such as the time displayed on the standby screen of the terminal 11, is set to the standard time. This makes it difficult for the user themselves to feel that the time has been shifted.

[5A. Combination of Notified Contents and Synchronization Method]

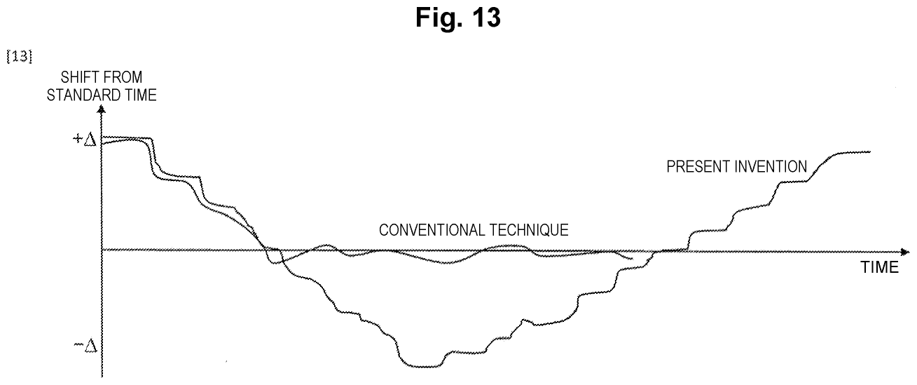

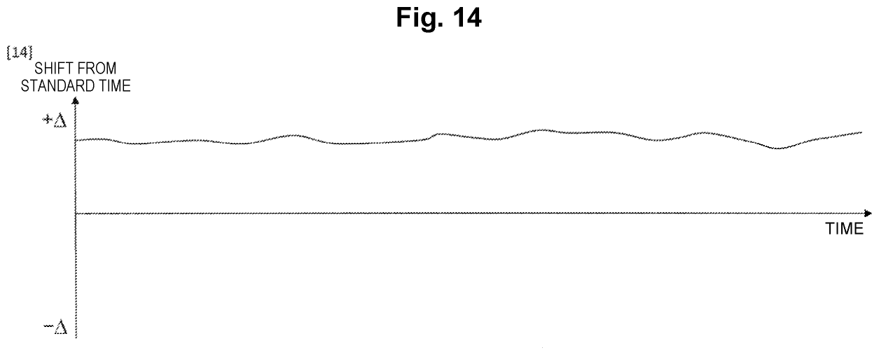

5A-1. Although the standard time is notified to the terminal on average, a time is distributed as needed so that the time with which the terminal synchronizes varies around the standard time. As shown in FIG. 13, by the synchronization time server 12 distributing a time so that it is T+Δ at one time and it is T−Δ at another time with respect to the standard time T, the time is not shifted on average but the time is shifted when viewed at individual times, so that traffic can be distributed. Thus, since the time synchronization server 12 randomly generates a distributed time around the standard time and performs time synchronization with the terminal 11, the terminal 11 is synchronized so as to operate with the standard time on average. Note that the time synchronization server 12 starts synchronization with a new time at the timing when the time synchronization of the terminal 11 has approximately been completed.
5A-2. A time is distributed so that the time with which the terminal synchronizes always advances or is delayed from the standard time. As shown in FIG. 14, the synchronization time server 12 distributes a time so that it is always T+Δ or T−Δ with respect to the standard time T. By distributing a time so that the shift amount Δ is different for each terminal, the time is not shifted as the entire system but the time is shifted for each terminal, so that traffic can be distributed.

[6A. Determination of Distributed Time to Each Terminal 11 in Time Synchronization Server 12]

6A-1. The time synchronization server 12 derives it based on the correct time and client information.
6A-2. The control server 60 derives a distributed time to each terminal 11, and transmits it to the time synchronization server 12 as part of the client information.

Subsequently, the case where the transfer device 12 is provided shown in FIG. 6 will be described.

### [3B. Specific Examples of Transfer Device]

Examples of the transfer device include the following devices:

3B-1. Switches and routers in the NW

### 3B-2. Servers in the NW

3B-3. A firewall and a proxy server located in front of the terminal
3B-4. A firewall installed on the terminal itself

[4B. Methods of Controlling Time Synchronization Packet]

The transfer device 12 shifts the time recognized by the terminal 11 by the following approaches.

4B-1. For a time synchronization packet transferred from the time synchronization server 70 in an upper network or a packet from the terminal 11, the transfer device 12 changes the order of queuing, or holds it in a buffer for a specific time period and then transfers it, thereby giving a delay. Hereinafter, this control will be referred to as “delay giving control”.
4B-2. The transfer device 12 rewrites a message corresponding to the distributed time in a time synchronization packet transferred from the time synchronization server 70 in the upper network. Hereinafter, this control will be referred to as “time rewriting control”.

[5B. Time Synchronization Packets to Be Controlled]

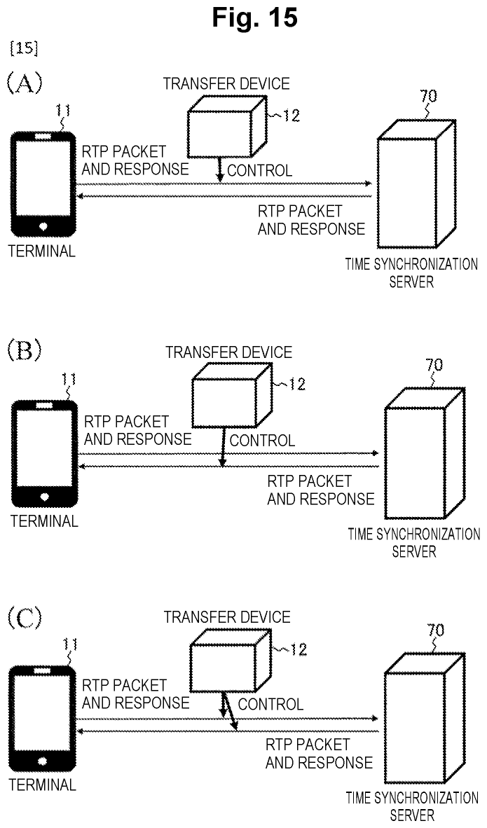

The transfer device 12 can perform the delay giving control only for uplink packets as shown in FIG. 15(A), perform the delay giving control or the time rewriting control only for downlink packets as shown in FIG. 15(B), or control packets in both directions (perform the delay giving control for uplink, and perform the delay giving control or the time rewriting control for downlink) as shown in FIG. 15(C).

[6B. Determination of Distributed Time to Each Terminal 11 in Transfer Device 12]

6B-1. The time synchronization server 70 derives it based on the correct time and client information.
6B-2. The control server 60 derives a distributed time to each terminal 11, and transmits it to the transfer device 12 as part of the client information. The transfer device 12 uses the time written in the information as the distributed time.

### Embodiment 2

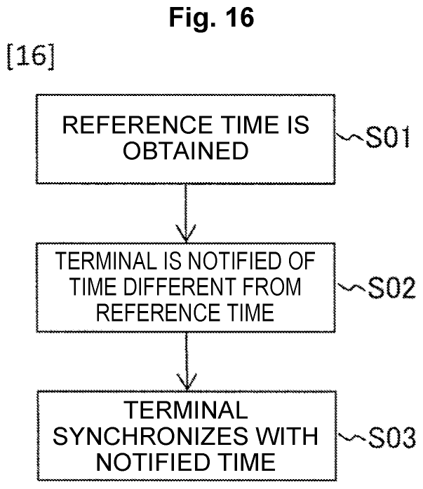

FIG. 16 is a diagram illustrating a communication method of this embodiment. In the communication method, in a communication system in which a synchronization time is distributed to a plurality of terminals that periodically generate traffic, a time different from a reference time (standard time) is distributed to at least one of the terminals as the synchronization time. The time distribution unit 12 obtains the reference time (standard time) generated by itself or the upper time synchronization server (step S01), and notifies a time shifted from the reference time so that the synchronization time is different for each terminal 11 (step S02), and each terminal 11 synchronizes with the time (step S03).

The communication method of the present invention is characterized in that a time distribution server (which corresponds to a time synchronization server or the like) that transmits time information to terminals (such as IoT equipment) distributes a time different from the standard time for each terminal, and the terminal performs communication on the basis of the distributed time. Further, the communication method of the present invention is characterized in that, for a time synchronizing packet transmitted from a time distribution server on the Internet to a terminal, a node or the like in the middle of the path performs transfer control or rewrites the packet, thereby causing the terminal to recognize a different time, and the terminal performs communication on the basis of the time.

In the present invention, the above features provide the effects that, since negotiation of transmission timing for each session is not required for a terminal that generates periodic traffic, communication resources can be utilized more efficiently, so it is possible not only to alleviate NW congestion but also suppress degradation in communication quality.

[Effect 1 of the Invention]

Since negotiation of transmission timing for each session is not required for a terminal that generates periodic traffic, the present invention can more efficiently utilize communication resources than the technique of Non-Patent Literature 2.

[Effect 2 of the Invention]

The occurrence time of a reserved event can be controlled from a network operator. The communication generation timing in a plurality of applications of the terminal can also be controlled from the network operator.

[Effect 3 of the Invention]

Degradation in communication quality is less likely to occur even when the amount of data generated in association with an event is large.

[Effect 4 of the Invention]

Since major modifications to terminals and an existing time synchronization server are not required, implementation is easy compared to the techniques of Non-Patent Literatures 1 to 3 that require implementation of a new protocol, dedicated equipment, or application.

### REFERENCE SIGNS LIST

11 Terminal
11a Time reception unit
11b Delay information exchange unit
12 Time distribution unit (time synchronization
server, transfer device)
13 Analysis unit
21 Time distribution unit
22 Upper stratum time holding unit
31 Client information aggregation unit
32 Delay information exchange unit
33 Distributed time determination unit
34 Control parameter determination unit
35a, 35b Time rewriting unit
50 Network (NW)
51 NW information acquisition unit
52 NW information processing unit
53 NW information transmission unit
60 Control server
61 NW information reception unit
62 Control information generation unit
63 Control information transmission unit
70 Upper time synchronization server
71 Time distribution unit
72 Delay information exchange unit

1. A communication system comprising
a time distribution unit that distributes a synchronization time to a plurality of terminals that periodically generate traffic,
wherein the time distribution unit distributes a time different from a reference time to at least one of the terminals as the synchronization time.

2. The communication system according to claim 1, further comprising an analysis unit that collects information on the traffic from the terminals, and determines the time different from the reference time.

3. The communication system according to claim 1, wherein
the reference time is a standard time notified from an upper stratum of the communication system, and
the time distribution unit is a time synchronization server that generates the time different from the reference time based on the standard time.

4. The communication system according to claim 1, wherein
the reference time is a time notified from a time synchronization server in an upper network of the communication system via a time synchronization packet, and
the time distribution unit is a transfer device that rewrites the time in the time synchronization packet to the time different from the reference time.

5. A communication method, wherein
in a communication system in which a synchronization time is distributed to a plurality of terminals that periodically generate traffic,
a time different from a reference time is distributed to at least one of the terminals as the synchronization time.

6. The communication method according to claim 5, wherein information on the traffic is collected from the terminals, and the time different from the reference time is determined.

7. The communication method according to claim 5, wherein
the reference time is a standard time notified from an upper stratum of the communication system, and
a time synchronization server in the communication system generates the time different from the reference time based on the standard time.

8. The communication method according to claim 5, wherein
the reference time is a time notified from a time synchronization server in an upper network of the communication system via a time synchronization packet, and
a transfer device in the communication system rewrites the time in the time synchronization packet to the time different from the reference time.
